(19) United States
(12) Patent Application Publication
(10) Pub. No.: US 2020/0004222 A1
(43) Pub. Date: Jan. 2, 2020

(54) METHOD OF SIMULATING THE RIGGING OF A SPACE

(71) Applicant: VINCI CONSTRUCTION, Paris (FR)

(72) Inventor: Jerome Stubler, Paris (FR)

(21) Appl. No.: 16/482,546

(22) PCT Filed: Jan. 29, 2018
(86) PCT No.: PCT/EP2018/052069

§ 371 Date: Jul. 31, 2019

(30) Foreign Application Priority Data
Feb. 1, 2017 (FR) 1750823

(51) Int. Cl. G05B 19/4097; G06F 3/0481; G06F 17/50

(52) U.S. Cl. CPC G05B 19/4097; G06F 3/04817; H04N 5/247; G06F 17/5004; G06F 3/04815

(57) ABSTRACT

A method for simulating the planning of a space using ornamental elements, in particular elements cut and/or machined from a sheet material (P1, Pn) and/or produced using said sheet or sheets (P1, Pn), in particular a material having random or special patterns, this method including the step of allowing a user, using a simulation tool, to simulate an installation configuration in which the ornamental elements are projected to scale onto an in particular 2D or 3D digital mockup of the space to be planned, at a desired position and with a desired orientation, the ornamental elements being displayed to scale with the mockup during this simulation, with their true appearance as resulting from a prior digital acquisition of the ornamental elements or of the or said sheets (P1, Pn) by an acquisition means.

The present invention relates to the planning of indoor or outdoor spaces by installing elements originating from cutting and/or machining of sheet materials having a rare or unique decoration, such as stones (marble, granite, etc.), woodwork with special grain, decorative panels, or boards used to adorn decorative elements through cutting and placing on furniture, walls or partitions.

This may involve the planning of buildings, boats or aircraft, inter alia.

Nowadays, architects have simulation tools allowing them to create 2D or 3D digital mockups of the space to be planned. These tools offer a realistic output, making it possible to accurately simulate the appearances of the planning elements. Using these tools, it is possible to choose the color, or even the texture, of the elements present in this space, and in some cases to introduce photo-realistic elements into them in the form of an approximate texture.

Publications US 2005/0081161 A1, U.S. Pat. Nos. 5,255,352, 6,005,969 and EP 2 996 055 A1 describe simulation tools of this type.

Architects need to design plans using ornamental elements produced from panels that they are not able to see, this in particular being the case for sheets of marble that are stored in vertical storage templates above one another and are difficult to observe. In addition, it is virtually impossible for them to define the position of the veins and to simulate the various possible cuts (open book, into four sheets, etc.) as it is impossible for them to see large numbers of sheets of marble before they are cut by stonemasons and to simulate cutting thereof. Given that the sheets do not have a uniform color and are likely to contain colored marbling or other random patterns, there is a risk of the appearance obtained after installing the elements not corresponding exactly to the desired effect. Furthermore, architects lose the possibility of “playing” with the particular textures of the panel, whether this be made for example of stone or of word, in order to position them while complying with manufacturing methods (cutting thickness, booklet cut in the thickness) on 2D or 3D projects and produce a realistic output. The fact that it is not possible to perform this operation often leads to additional rework operations, making it necessary for example to remove an element containing excessively visible unsightly marbling or inappropriate hues. To reduce this risk, in the prior art, the architect furthermore has to be present on the project, but this leads to additional cost and impacts his productivity. In addition, the observation of the panels at the manufacturers is likely to take place in lighting conditions that are very different from that of the site at which they are installed, and it is difficult to accurately imagine the possible effects for them. Lastly, when the elements are installed in the context of renovation works on a building that is still partially occupied, any delay in the project linked to a difference between the expected appearance and the obtained appearance is extremely disadvantageous.

Moreover, joiners and stonemasons have numerical control machines that make it possible, on the basis of a work file, to cut the sheets into edges and into slices and to machine them to the desired shape, and to produce any required openings, chamfers, recesses or grooves therein. These machines may be controlled on the basis of descriptive files of the elements to be produced. They are not however intended to interact with the simulation tools that the architects have and therefore allow the architects to easily verify that their project fits within the existing sheets.

There is therefore a need to develop new simulation and production tools to facilitate the planning of spaces, in particular by installing elements obtained by cutting sheet materials, such as marble or other ornamental stones, or woodwork elements with a unique appearance, and the invention aims to address this.

One subject of the invention, according to a first of its aspects, is thus a method for simulating the planning of a space using ornamental elements, in particular elements cut and/or machined from a sheet material and/or produced using said sheet or sheets, in particular a material having random or special patterns, this method including the step of:
allowing a user, using a simulation tool, to simulate an installation configuration in which the ornamental elements are projected to scale onto an in particular 2D or 3D digital mockup of the space to be planned, at a desired position and with a desired orientation, the ornamental elements being displayed to scale with the mockup during this simulation, with their true appearance as resulting from a prior digital acquisition of the ornamental elements or of the or said sheets, by an acquisition means.

The sheet material may be an ornamental stone, preferably marble, or any other stone, or one or more sheets of aged wood with special grain or decorative features to be preserved, or any flat or non-flat sheet having special patterns that should be reproduced in order to decorate furnishing or decorative elements in said space to be planned.

The expression “with their true appearance” means that at least the random or special patterns of the sheets are visible with the simulation tool, to within the resolution of the system and after scaling, the accuracy preferably being better than a centimeter, better still better than 0.5 cm or 0.1 cm. Preferably, the true appearance also comprises the true reproduction of the color, to within the accuracy of the calibration, and preferably includes reflectometric appearances.

The digital acquisition may be performed using a set of several cameras allowing 3D scaling using a photogrammetric reconstruction method.

The prior digital acquisition is advantageously performed by shooting in predefined lighting conditions, in particular standardized lighting conditions, allowing reproduction of the appearance, by the simulation tool, that is preferably as exact as possible.

In particular, the digital acquisition may include:
photographic shooting,
measurement of coefficients of reflection and/or of transparency,
measurement of the real dimensions so as to perform scaling.

The invention may thus allow a user, using the simulation tool, to simulate an installation configuration in which the sheets and/or the elements produced by cutting and/or machining thereof are projected onto the 2D or 3D digital mockup of the space to be planned, at a desired position and with a desired orientation, the sheets and/or elements being displayed to scale with the mockup during this simulation, with their true appearance as resulting from the prior digital acquisition of the sheets of said material by the acquisition means.

Preferably, the simulation tool is designed to allow the user to view the location of the cut and/or machined sheets on the blank panels in real time in order to verify the feasibility of the cuts. The simulation tool may include the normal functionalities for editing the various components of the mockup, and for choosing the viewpoint and the lighting conditions. The simulation tool may have access to libraries of components such as woodwork elements, opening elements, frames, furniture elements, decorative elements, etc., allowing the user to design the plan.

Preferably, the simulation tool is configured so as to make it possible, once the installation of the elements has been chosen, to possibly program the cutting of the elements on manual or numerical control machines, in accordance with previously established cutting plans.

The invention offers the architect in charge of the project the possibility of seeing the appearance that will actually be obtained after the elements are installed, taking into account the actual patterns of the sheets and the position of the cut and/or machined elements within these sheets.

Thus, the architect may look to limit the visibility of unsightly marbling for example by keeping the elements that include said marbling within the cladding of zones that are visible to a small extent or less well lit. As a variant, the architecture may by contrast look to exploit the decorative appearance of certain natural patterns marked in the sheets when designing the elements, in particular by choosing their orientation and their location in the planned space.

The invention facilitates the layout operation. It is possible to use the simulation tool to generate a specification of the cuts to be performed, in manual or controlled form.

The invention is very particularly suitable for the installation of marble elements, but may be applied to other materials having random or special patterns, in particular natural materials such as granite, slate or other ornamental stones. The sheet material is preferably marble.

The simulation tool may be configured so as to automatically generate a projection of said elements and/or sheets onto the digital mockup, from a selection, by the simulation tool and/or by the user, of the available sheets and/or elements. The simulation tool may thus be taught in real time with regard to a stock of sheets available in the stonemason's store, and limit the choice of the user of the simulation tool to this stock in real time.

The simulation tool may be designed to generate a 2D or 3D view of the digital mockup with the elements and/or sheets projected on top.

The method may include the step of displaying the result of the simulation, for example on a virtual reality headset whose screen is calibrated from a colorimetric standpoint.

The method may include the step of acquiring, using the digital acquisition means, the true appearance of at least one face of each sheet in predefined lighting conditions, and the step of generating, for each sheet, one or more corresponding images able to be used by the simulation tool.

The acquisition may be performed in standardized lighting, in particular in diffuse light and at a known color temperature, for example under daylight illuminant D65.

For the case of stones, for example marble, the acquisition is performed for example upon receipt of the sheets by the stonemason; as a variant, the acquisition is performed at the quarry. The images may be remotely transmitted to a dedicated site allowing the architect to perform his simulations via the simulation tool.

This also applies to any other panel having a particular pattern, for example aged woodwork, murals or reinstalled boards.

The method may include positioning, on a sheet, at least one marker in the field of view of the acquisition means, this positioning being performed prior to the acquisition. This may be a marker carried by an adhesive support that is bonded to the sheet. It may also be a marker that is simply placed on the sheet during the acquisition, or a marker printed or etched finely thereon, able to be detected by the acquisition means. Where applicable, edges of the sheet are used as markers if these have been corrected in a predefined manner. The marker that is used preferably gives the direction of two axes that are perpendicular to one another.

The use of a photogrammetry method with possible positioning of a marker or use of a rangefinder elegantly makes it possible to perform the digital acquisition, with scaling of the shot.

The method may include positioning, on an ornamental element or a sheet, at least one scale indicator in the field of view of the acquisition means, this positioning being performed prior to the acquisition. This may be a scale indicator carried by an adhesive support that is bonded to the sheet prior to the acquisition. These may also be markers that are printed or etched finely onto the sheet, able to be detected by the acquisition means. The scale indicator includes at least two points the spacing between which is predefined, or even three points the spacing between which is predefined, and these may be graduations or one or more segments of known length.

The method may also include the use of a rangefinder during the shooting.

Advantageously, the marker and the scale indicator are carried by one and the same support and coincide. This is for example an orthonormal marker or a grid whose geometry and dimensions are known.

The method may include positioning at least one identifier in the field of view of the acquisition means, on a sheet of the material prior to the acquisition, in particular an identifier carried by an adhesive support. This is for example a barcode or a QR code. It is also possible to equip the sheet with an identifier that is not visible to the acquisition means, for example an RFID chip bonded to the sheet.

Where applicable, the identifier is produced so as also to be able to serve as marker and/or scale indicator.

The method may include positioning a colorimetric calibration sight in the field of view of the acquisition means, prior to the acquisition. Such a sight may facilitate the calibration of the acquisition means, by having one or more zones whose colorimetric properties, in particular spectral reflectance, are known with accuracy.

The method may include the step of generating a file able to be read by a numerical control machine, this file containing data for the automated cutting and/or machining of the sheets in order to produce the elements intended to reproduce a selected installation configuration using the simulation tool. This file is generated at the end of the simulation when the choice of the elements has been confirmed. The file is preferably generated by the simulation tool itself. As a variant, the data required to generate the files are transmitted by the simulation tool to a computer responsible for generating the files intended for the numerical control machines.

The simulation tool may be configured so as to display the sheets from which the elements are able to be produced. The sheets may be displayed to a scale allowing the patterns thereof to be seen.

The simulation tool may be used, as the sheets are cut, to display the remaining surface of each sheet available to produce ornamental elements.

The simulation tool may be configured so as to display the remaining surface of a sheet available to produce elements. This may assist the user in the selection of the surfaces intended to produce the elements; for example, the user may see that an interesting pattern is present in an as yet unused zone of the sheet, or by contrast that the as yet unused surface of the sheet may not be used for certain elements due to unsightly patterns present therein.

The simulation tool may thus be configured so as to allow the user, during the simulation, to view the consumed and remaining parts of the original sheet or sheets, so as in particular to allow usage thereof to be optimized.

The simulation tool may be designed to automatically generate predefined patterns from the available elements and/or sheets, in particular symmetrical patterns, by cutting to a thickness or patterns with dual symmetry, for example by cutting to four thicknesses.

The simulation tool may be designed to select elements to be produced by cutting and/or machining the available sheets, making it possible to produce patterns having a predefined degree of symmetry. For example, the simulation tool may search among the available sheets for those that make it possible to produce elements having common points due to the shape and/or the color and/or the design of certain natural patterns. In this case, the simulation tool may include an image analysis engine for comparing images and generating scores on the basis of the criteria that are selected; elements may then be proposed to the user on the basis of the scores that are obtained. The architect may thus be assisted in his esthetic research work and save time.

The data resulting from the simulation may be supplied automatically, through appropriate interfacing, to a database called BIM (“Building Information Model”), concentrating technical and economic data for the works, and being constructed as the project progresses; the data serving to control the cutting and/or machining system may thus be associated, within this database, with other data regarding the installation thereof, for example a provisional installation and/or delivery schedule, the cost thereof, the name of the stonemason, of the installer, the name of the project, etc.

Another subject of the invention, according to another of its aspects, is a method for cutting and/or machining a sheet material, in order to plan a space in accordance with a selected installation configuration using the simulation tool according to the invention, including the step of:
controlling at least one numerical control machine on the basis of a configuration selected by the user at the end of the simulation, so as to cut and/or machine the sheets so as to produce the elements for reproducing the selected installation configuration and/or
generating a precise cutting specification, used with or without numerical control.

In particular when the operator responsible for cutting and/or machining the sheets is the same as the operator who has the sheets before the simulation is launched, the cutting and/or machining step may include the step of acquiring, prior to the simulation, using a digital acquisition means, the true appearance of at least one face of each sheet in predefined lighting conditions, as explained above.

Another subject of the invention is a method for planning a space, in which the elements cut and/or machined by implementing the method as defined above are assembled in a configuration that corresponds to the one selected in the simulation.

Another subject of the invention is a computer program product containing, in a memory or on a support, a set of instructions able to be read by a processor of a simulation tool, such as a computer, these instructions, when they are executed, prompting the processor to simulate an installation configuration in which ornamental elements such as sheets and/or elements produced by cutting and/or machining thereof are projected to scale onto a digital mockup of a space to be planned, at a position and with an orientation that are desired by a user who is able to view the projection of the ornamental elements onto the digital mockup, the ornamental elements being displayed with their true appearance to scale with the mockup during this simulation, as resulting from a prior digital acquisition of the sheets by an acquisition means, the sheet material having for example random patterns or any other special pattern. Preferably, the program contains instructions for generating a file for controlling a numerical control machine so as to cut the sheet or sheets of the ornamental elements as resulting from the simulation. The program may contain any instructions for implementing the simulation method according to the invention as defined above.

Another subject of the invention, independently or in combination with the above, is a computer program product containing, in a memory or on a support, a set of instructions able to be read by a processor of a simulation tool, these instructions, when they are executed, prompting the processor to simulate an installation configuration in which sheets and/or elements produced by cutting and/or machining thereof are projected onto a digital mockup of a space to be planned, to scale with the mockup, at a position and with an orientation that are desired by a user, allowing the user to view the projection of the elements, and to simulate the consumed and remaining parts of the original sheet or sheets, so as in particular to allow use thereof to be optimized.

Other features and advantages of the present invention will emerge upon reading the following description, non-limiting exemplary embodiments thereof, and upon examining the appended drawing, in which:

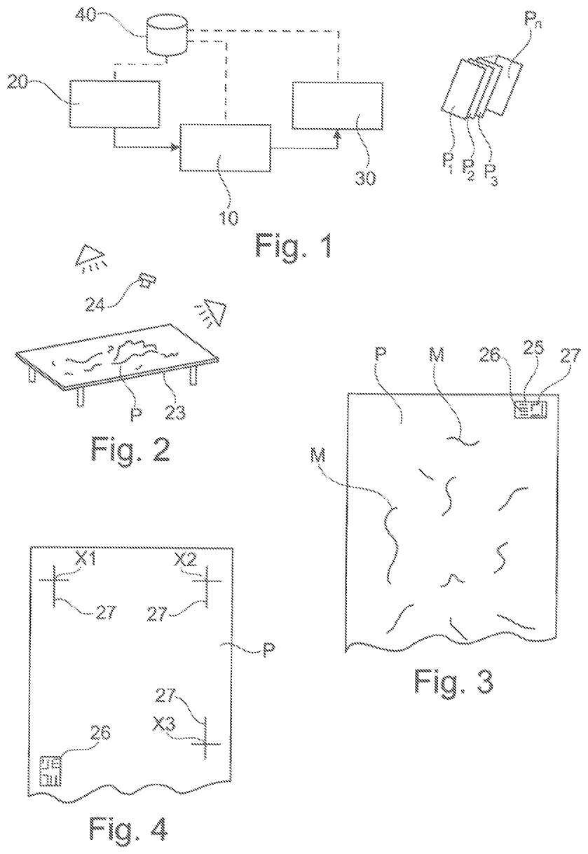

FIG. 1 schematically and partially shows an example of a system for implementing the invention,

FIG. 2 shows an example of an acquisition means in more detail,

FIG. 3 partially and schematically shows a sheet equipped with an identifier, with a marker and with a scale indicator, ready for the acquisition,

FIG. 4 is a view analogous to FIG. 3 of a variant embodiment of the marking on the sheet, and

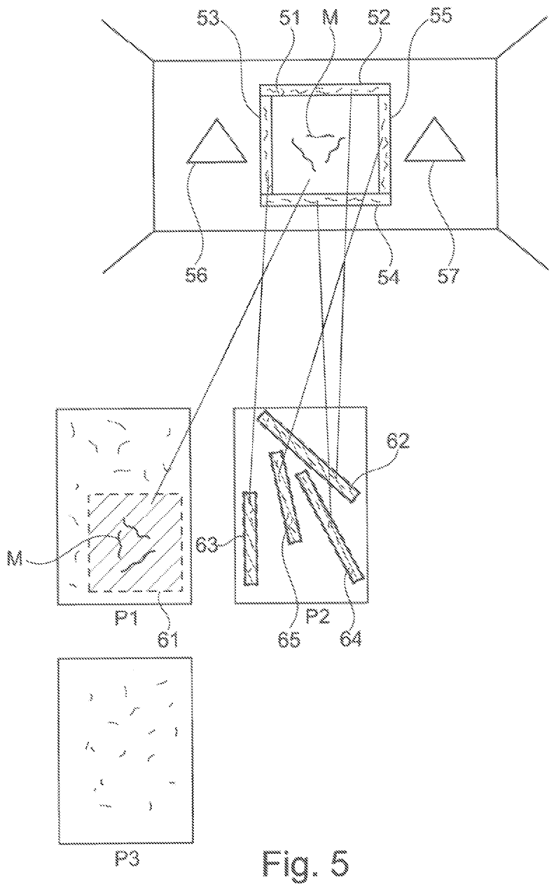

FIG. 5 shows an example of a display of the simulation tool.

The system 1 according to the invention, shown in FIG. 1, includes a simulation tool 10, an acquisition system 20 (also called acquisition means) and a cutting and/or machining shaping system 30.

FIG. 1 also schematically shows a set of sheets P1, . . . Pn of a material having random patterns, for example marble, in a store, processed by the acquisition system 20 and awaiting cutting and/or machining by the shaping system 30.

The acquisition system 20 makes it possible to record images of at least one face of each of the sheets P1, . . . Pn for the purpose of the use thereof by the simulation tool 10.

The true appearance of the sheets is preferably acquired in diffuse light lighting conditions and under at least one predefined illuminant.

It may be advantageous for the acquisition to allow the true appearance to be simulated under lighting conditions close to the actual lighting conditions of the planned space.

To this end, the acquisition may be performed so as to make it possible to then simulate the appearance in at least two light temperatures and/or in at least two standardized predefined lighting conditions, for example with a predefined illuminant in accordance with the CIE, for example D65 (daylight).

The acquisition system 20 may include any standardized shooting system. The sheet P may rest horizontally on a bench 23 designed for handling thereof.

A camera 24 or any other optical acquisition means, for example using photogrammetry, is appropriately positioned so as to capture at least one view of the sheet, for example is placed above the sheet P, with its line of sight oriented perpendicular thereto.

The focal length of the lens is preferably chosen so as to limit distortions. If such distortions occur, these are preferably corrected using software, either by sampling or automatically by superimposing images using photogrammetry.

Preferably, at least one support 25, on which there is an identifier 26 of the sheet, is positioned on the sheet, as illustrated in FIG. 3. This is for example an optical code, for example a barcode or a QR code.

The support 25 is for example a film or an adhesive paper, which is preferably opaque, on which the identifier is printed.

Preferably, the identifier is able to be read by the shaping system 30, thereby allowing it to automatically recognize the sheet to be processed.

An orthonormal marker 27 may advantageously be present on the support 25, so as to allow the image to be scaled and the coordinates of any point selected on the image to be known with accuracy. In this case, the support 25 is preferably placed at a predefined location and with a predefined orientation on the sheet.

The acquisition makes it possible to record the precise geometric position of the patterns M of the material and the colorimetric characteristics of the material. As the marker 27 is placed in the field of view of the camera 24, the image may be processed after it is acquired so as to make it possible to know the position of each point of the image on the real sheet. The marking data associated with the image are generated in a format compatible for subsequent use thereof by the simulation tool.

The field of view of the camera 24 may be such that it incorporates the entire sheet all at once. As a variant, several views of the sheet at various locations are taken and then concatenated within a single image corresponding to the entire sheet. In this case, it is for example possible to homogeneously light only the region of the sheet that is situated in the field of view of the camera 24 in the corresponding shot. The camera 24 may then be mounted, with the lighting system, on a frame able to move along the sheet. As a variant, the frame is fixed and the sheet is moved in relation thereto. It is also possible to film the sheet with a camera that is moved along the sheet, and to generate the image of the entire sheet through software.

The acquisition may also be performed through photogrammetry, and the scaling may be based on the use of a rangefinder where applicable.

In the variant of FIG. 4, three points X1, X2, X3 are marked on the sheet P, the spacing between which points is known, as is the angle between the vectors X2X1 and X2X3, in this case a right angle. The points X1 to X3 are for example plotted on the sheet using a suitable printer, which is able to move in relation to the sheet, or are even plotted manually using a template or other suitable accessory.

The images of the sheets thus acquired may be stored locally and/or in a remote database 40, accessible to the simulation tool 10 and/or to the shaping system 30, for example via an Internet connection.

The simulation tool 10 is advantageously designed so as to be able to display a 3D virtual digital mockup of the space to be planned by displaying the various surfaces intended to be adorned on the basis of elements that are cut and/or machined from the sheet material, or even with the sheets themselves.

The simulation tool 10 is advantageously designed so as to allow the user to view each available sheet of material and select therein the profile of the element or elements to be produced through cutting and/or machining. The available sheets may thus be displayed in real time after interrogating the database 40.

The functionalities offered by the simulation tool according to the invention may be integrated into the software for generating the digital mockup or be provided by an additional program in the form of an “add-on” compatible with this software.

The simulation tool 10 includes any sufficiently powerful computing means, for example a microcomputer equipped with a screen and with a keyboard and with a mouse, and having a sufficiently powerful graphics card to display the digital mockup.

The display may advantageously take place on a screen that is calibrated from a colorimetric standpoint, such that the elements produced with the sheets are able to be displayed with their true color.

A virtual reality headset may be used where applicable.

An example of what may be displayed on the screen is shown highly schematically in FIG. 5, it being understood that the invention is not limited to a particular graphical interface (GUI).

This figure shows surfaces 51 to 55 of the digital mockup onto which respective ornamental elements 61 to 65 selected on the sheets P1 and P2 have been projected, and standby surfaces 56 and 57, onto which no element has yet been projected.

The element 61 that occupies the surface 51 has been selected from the sheet P1, the cutting line to be made in the sheet P1 in order to produce the element 61 being able to appear as a discontinuous line on the depiction of this sheet, as illustrated.

The user may have the option of selecting an element where he wants it within the sheet of his choice so as to be able to benefit from a particular pattern therein. The user may position the element in the orientation that he wants on the digital mockup. For example, as illustrated in FIG. 5 in the case of the element 61, the user may subject the element to a 90° rotation in the clockwise direction with respect to the orientation in which the pattern was presented to him on the screen.

The simulation tool 10 may be designed so as to select a zone on a sheet so as to fill a surface of the digital mockup, the user clicks on the sheet of his choice with the mouse and moves it to the surface by keeping his finger pressed down (“click and drop”). Next, once the sheet has been assigned to a surface, the user is able to move the sheet within this surface while viewing the sheet through the surface as through an open window, the zones of the sheet that go beyond the surface possibly appearing in gray. He may rotate the sheet and adjust the position of the zone that will be cut in order to produce the element. Once the zone of the sheet that is desired precisely by the user appears on the surface, with the correct orientation, the user may signal this to the simulation tool using a suitable command, and the simulation tool then records the corresponding parameters, in particular the identifier of the sheet, the destination of the element, its location and its orientation on the mockup and on the sheet, the noteworthy points of its profile, and more generally any useful data for then making it possible to automatically cut and/or machine the element on the sheet using the shaping system 30.

A zone of the sheet that is selected to form an ornamental element on the digital mockup may appear on the sheet with a different appearance for the rest of the simulation, for example shaded, in order to remind the user that the corresponding zone of the sheet is no longer available. To avoid the user creating another element with zones of the sheet that are already selected to form one or more elements, the simulation tool limits the use of the sheet to only zones in which it is still possible to cut and/or machine new elements compatible with the surface to be adorned.

Preferably, the simulation tool 10 is designed to offer a function for pre-filling the surfaces to be adorned, after selecting one or more available sheets, the appearance of each of these sheets already having undergone prior acquisition, as explained above.

For example, the user indicates the sheets to be used for certain elements, depending on their color, without precisely indicating where to cut each element in the sheet or how to position the various elements on the 3D digital mockup on the corresponding surfaces.

The simulation tool itself selects the zones to be cut in the sheet to produce the elements, and projects them to scale onto the digital mockup.

The user then has the possibility of modifying what is proposed by the simulation tool 10, for example by changing certain elements or by modifying the orientation thereof.

Advantageously, this pre-filling is performed in accordance with one or more criteria that are predefined and/or able to be selected by the user, such as for example minimizing material losses, minimizing the visibility of certain patterns and/or colors, for example minimizing the visibility of certain color hues, maximizing the visibility of certain patterns, for example marbling oriented in a certain direction, inter alia.

By default, the criterion according to which the pre-filling is performed may be minimizing material losses.

The simulation tool 10 may allow the user to enter the point from which the mockup is observed, and the direction of observation, and also to enter the characteristics of the lighting of the planned space, so as to allow him to visualize this space in conditions that are as close as possible to reality.

Preferably, the patterns of the sheets are displayed while also displaying the reflections of the light and the effect of the temperature of the lighting on the apparent color of the sheets.

Once the sheets and elements have been selected, the simulation tool 10 generates one or more files intended for the shaping system 30. These files are for example loaded into the remote database 40. These files may merge with other data relating to the works, within a database called BIM (“Building Information Model”), concentrating technical and economic data for the works, and being constructed as the project progresses; the data serving to control the cutting and/or machining system may thus be associated, within this database, with other data regarding the installation thereof, for example a provisional installation and/or delivery schedule, the cost thereof, the name of the stonemason, of the installer, the name of the project, etc.

The shaping system 30 includes any cutting means suitable for producing the elements. It is for example a cutting system using a disk or a diamond wheel, a laser or a waterjet, which is controlled numerically.

The shaping system 30 may also where applicable perform a surface action, such as polishing or producing chamfers or roundings.

Of course, the invention is not limited to the examples that have just been described.

For example, the selection and the positioning of the elements on the 3D digital mockup may be performed in yet another way, for example using a touchscreen or a graphical tablet.

The simulation tool 10 may be designed to make it possible to project other types of cladding or decorative element, images and/or 3D scans of which have been acquired, onto corresponding surfaces. The sheets from which the ornamental elements are cut may thus be woodwork.

Although it is preferred for the elements to be cut automatically following the definition of the elements in the simulation using the simulation tool, as a variant, the simulation tool generates a cutting specification, and the cutting is performed manually in accordance with this specification.

1. A method for simulating the-planning of a space using ornamental elements, the method including the step of:
allowing a user, using a simulation tool, to simulate an installation configuration in which the ornamental elements are projected to scale onto a digital mockup of the space to be planned, at a desired position and with a desired orientation, the ornamental elements being displayed to scale with the mockup during this simulation, with their true appearance as resulting from a prior digital acquisition of the ornamental elements.

2. The method as claimed in claim 1, the ornamental elements being cut and/or machined from a sheet materia and/or produced using said sheet or sheets, the sheet material being an ornamental stone or any other stone, or one or more sheets of aged wood with special grain or decorative features to be preserved, or any flat or non-flat sheet having special patterns that should be reproduced in order to decorate furnishing or decorative elements in said space to be planned.

3. The method as claimed in claim 1, the simulation tool being configured so as to automatically generate a projection of said ornamental elements, onto the digital mockup, from a selection, by the simulation tool and/or by the user, of the available ornamental elements.

4. The method as claimed in claim 1, the simulation tool being designed to generate a 2D or 3D view of the digital mockup with the ornamental elements projected above.

5. The method as claimed in claim 1, including the step of acquiring, using the digital acquisition means, the true appearance of the or of each ornamental element in predefined lighting conditions, and the step of generating, for each ornamental element, one or more to-scale corresponding images able to be used by the simulation tool.

6. The method as claimed in claim 5, the acquisition being performed in standardized lighting, and at a known color temperature.

7. The method as claimed in claim 1, including positioning, on an ornamental element, at least one marker in the field of view of the acquisition means, this positioning being performed prior to the acquisition.

8. The method as claimed in claim 1, the digital acquisition being performed using a set of several cameras allowing 3D scaling using a photogrammetric reconstruction method, and the scaling being performed either using a rangefinder or by positioning a marker in the field of view of the acquisition means, this positioning being performed prior to the acquisition.

9. The method as claimed in claim 1, including positioning, on an ornamental element, at least one scale indicator in the field of view of the acquisition means, this positioning being performed prior to the acquisition.

10. The method as claimed in claim 1, including positioning at least one identifier, in the field of view of the acquisition means, on the ornamental element prior to the acquisition.

11. The method as claimed in claim 1, including positioning a colorimetric calibration sight in the field of view of the acquisition means, prior to the acquisition.

12. The method as claimed claim 1, the ornamental elements being cut and/or machined from a sheet material and/or produced using said sheet or sheets, the method including the step of generating a file able to be read by a numerical control machine, this file containing data for the automated cutting and/or machining of the sheet or sheets in order to produce the ornamental elements intended to reproduce a selected installation configuration using the simulation tool.

13. The method as claimed in claim 12, the data resulting from the simulation being supplied automatically to a database called BIM (“Building Information Model”), concentrating technical and economic data for the works.

14. The method as claimed in claim 1, the simulation tool automatically generating predefined patterns from the available ornamental elements.

15. The method as claimed in claim 1, wherein the ornamental elements is cut and/or machined from a sheet material and/or produced using said sheet or sheets and the simulation tool is used, as the sheets are cut, to display the remaining surface of each sheet available to produce ornamental elements.

16. The method as claimed in claim 1, wherein the simulation tool is used to generate a specification of the cuts to be performed, in manual or controlled form.

17. A method for cutting and/or machining a sheet material in order to plan a space in accordance with a selected installation configuration using the simulation tool of the method as claimed in claim 1, including the step of:
controlling at least one numerical control machine on the basis of a configuration selected by the user at the end of the simulation, so as to cut and/or machine the sheets so as to produce the ornamental elements for reproducing the selected installation configuration.

18. The method as claimed in claim 17, including the step of acquiring, prior to the simulation, using a digital acquisition means, the true appearance of at least one face of each sheet in predefined lighting conditions.

19. A method for planning a space, in which the elements cut and/or machined by implementing the method as claimed in claim 17 are assembled in a configuration that corresponds to the one selected in the simulation.

20. A computer program product containing, in a memory or on a support, a set of instructions able to be read by a processor of a simulation tool, these instructions, when they are executed, prompting the processor to simulate at least one installation configuration in which ornamental elements, are projected onto a digital mockup of a space to be planned, at a position and with an orientation that are desired by a user who is able to view the projection of the ornamental elements onto the digital mockup, the elements being displayed with their true appearance to scale with the mockup during this simulation, as resulting from a prior digital acquisition of the ornamental elements by an acquisition means.

21. A computer program product containing, in a memory or on a support, a set of instructions able to be read by a processor of a simulation tool, these instructions, when they are executed, prompting the processor to simulate an installation configuration in which sheets and/or elements produced by cutting and/or machining thereof are projected onto a digital mockup of a space to be planned, to scale with the mockup, at a position and with an orientation that are desired by a user, allowing the user to view the projection of the elements, and simulating the consumed and remaining parts of the original sheet or sheets.
